(19) United States
(12) Patent Application Publication
(10) Pub. No.: US 2009/0067741 A1
(43) Pub. Date: Mar. 12, 2009

(54) ADAPTIVE IMAGE PROCESSING DEVICE AND METHOD THEREOF

(75) Inventors: Lien-Wei Lee, Taipei City (TW); Tsung-Ping Wei, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: BEYOND INNOVATION TECHNOLOGY CO., LTD., Taipei City (TW)

(21) Appl. No.: 12/121,799

(22) Filed: May 16, 2008

(30) Foreign Application Priority Data
Sep. 12, 2007 (TW) 96134022

(51) Int. Cl. G06K 9/40

(52) U.S. Cl. 382/263

(57) ABSTRACT

An adaptive image processing device is provided. The adaptive image processing device includes an image processing unit, a control unit, and a selection unit. The image processing unit receives an image data, for simultaneously execute a plurality of image processing processes to the image data, so as to obtain a plurality of output values. The control unit is coupled to the image processing unit, for executing at least one image analysis to the image data, and obtaining at least one selection signal. The selection unit receives the output values and selects one from the output values to output according to the selection signal. As such, the adaptive image processing device is adapted for discriminatively processing different pixels according to a result of analyzing image data of the image.

### CROSS-REFERENCE TO RELATED APPLICATION

This application claims the priority benefit of Taiwan application serial no. 96134022, filed on Sep. 12, 2007. The entirety of the above-mentioned patent application is hereby incorporated by reference herein and made a part of specification.

### BACKGROUND OF THE INVENTION

1. Field of the Invention

The present invention generally relates to an image processing technology, and more particularly, to an image processing technology adapted for discriminatively processing different pixels according to a result of analyzing image data of the image.

2. Description of Related Art

Sharpness processing technology and smoothness processing technology are typical image processing technologies. Sharpness processing technology is adapted for making an image appear more vivid, while smoothness processing technology is adapted for making an image appear softer.

A conventional sharpness processing technology includes executing a sharpness process to an image in its entirety, in which regions undesired to be processed of the image have to be processed as well. For example, when processing a portrait of a person with the conventional sharpness processing technology, although hairs would be processed to become more vivid as desired, flaws on the skin are also unfortunately made outstanding, whereby unappreciated fleck may likely occur.

Similarly, a conventional smoothness processing technology is to execute a smoothness process to an image in its entirety, in which regions undesired to be processed of the image have to be processed as well. For example, when processing a portrait of a person with the conventional smoothness processing technology, although flaws on the skin would be processed to become relative unobvious as desired, the hair, however, are also unfortunately blurred.

In order to provide a solution to the aforementioned difficulties, the conventional technology divides an image into different regions by manually selecting, and then discriminatingly executes image processing to different regions. However, such a method is too time-consuming and labor-consuming, and likely to cause false contours at boundary of the regions.

Accordingly, the conventional technology provides another solution, in which the image, in its entirety, is first executed with the sharpness image processing, and then executed with the smoothness image processing, or is first executed with the smoothness image processing, and then executed with the sharpness image processing. This solution provides little improvement to the image quality, while is likely to cause a second distortion.

### SUMMARY OF THE INVENTION

Accordingly, the present invention is directed to an adaptive image processing device for improving an image quality.

The present invention is also directed to an adaptive image processing device, which is adapted for discriminatively executing image processing to different pixels according to each pixel and data of pixels therearound in the image, so as to improve an image quality.

The present invention provides an adaptive image processing device. The adaptive image processing device includes an image processing unit, a control unit, and a selection unit. The image processing unit receives an image data, for simultaneously execute a plurality of image processing processes to the image data, so as to obtain a plurality of output values. The control unit is coupled to the image processing unit, for executing at least one image analysis to the image data, and obtaining at least one selection signal. The selection unit receives the output values and selects one from the output values to output according to the selection signal.

According to an embodiment of the present invention, the adaptive image processing device further includes a delay unit. The delay unit is adapted for delaying the image data from being inputted into the image processing unit and the control unit.

According to an embodiment of the present invention, the image processing unit includes a sharpening unit, a smoothing unit, and a bypassing unit. The sharpening unit is coupled to the selection unit for executing a sharpness processing process to the image data so as to obtain one of the output values. The smoothing unit is coupled to the selection unit for executing a smoothness processing process to the image data so as to obtain one of the output values. The bypassing unit is coupled to the selection unit for executing a bypassing process to the image data so as to obtain one of the output values. According to another embodiment of the present invention, the sharpening unit and the smoothing unit adjust degrees for sharpness processing and smoothness processing respectively according to an adjusting data.

According to an embodiment of the present invention, the sharpening unit includes a plane sharpening unit, a horizontal sharpening unit, and a vertical sharpening unit. The plane sharpening unit is coupled to the selection unit for executing a plane sharpness processing process to the image data so as to obtain a plane sharpening output value, which serves as one of the output values. The horizontal sharpening unit is coupled to the selection unit for executing a horizontal sharpness processing process to the image data so as to obtain a horizontal sharpening output value, which serves as one of the output values. The vertical sharpening unit is coupled to the selection unit for executing a vertical sharpness processing process to the image data so as to obtain a vertical sharpening output value, which serves as one of the output values.

According to an embodiment of the present invention, the control unit includes a frequency analysis unit and a configuration detecting unit. The configuration detecting unit includes a plurality of built-in image data models. The configuration detecting unit receives the image data and compares the received image data with the built-in image data models so as to obtain a first selection signal. The frequency analysis unit receives the image data and executes a frequency analysis to the received image data so as to obtain a second selection signal. The first selection signal and the second selection signal constitute the selection signal. According to another embodiment of the present invention, the frequency analysis executed by the frequency analysis unit includes a horizontal high frequency analysis, a vertical high frequency analysis, or a low frequency analysis.

The present invention is further directed to an adaptive image processing method. The adaptive image processing method includes receiving an image data of an input image, and executing a plurality of image analysis so as to obtain a selection signal. Then, an output value is obtained according to the selection signal. The output value serves as a pixel of an output image corresponding to the input image. The output value is one of a plurality of output values obtained by executing a plurality of image processing processes to the image data. The plurality of image processing processes corresponds to the plurality of image analysis respectively.

According to an embodiment of the present invention, the step of obtaining the output value according to the selection signal further includes executing one of the image processing processes to the image data according to the selection signal so as to obtain the output value. According to another embodiment of the present invention, the selection signal indicates a frequency characteristic of the image data. According to a further embodiment of the present invention, if the selection signal indicates that the image data matches with an image data model, the output value obtained according to the selection signal is obtained by executing a plane sharpness processing process to the image data. Further, if the selection signal indicates that the image data has a high frequency characteristic, the output value obtained according to the selection signal is obtained by executing a sharpness processing process to the image data. Furthermore, if the selection signal indicates that the image data has a low frequency characteristic, the output value obtained according to the selection signal is obtained by executing a smoothness processing process to the image data.

According to an embodiment of the present invention, the adaptive image processing method further includes executing the plurality of image processing processes to the image data, so as to obtain the plurality of output values. According to a further embodiment of the present invention, the image processing processes include a plane sharpness processing process, a horizontal sharpness processing process, a vertical sharpness processing process, a smoothness processing process, or a bypassing process.

According to an embodiment of the present invention, the image analysis includes a configuration detecting analysis, a horizontal high frequency analysis, a vertical high frequency analysis, or a low frequency analysis. The configuration detecting analysis, the horizontal high frequency analysis, the vertical high frequency analysis, and the low frequency analysis respectively correspond to the plane sharpness processing process, the horizontal sharpness processing process, the vertical sharpness processing process, and the smoothness processing process.

The present invention discriminatively processes different pixels of an image according to each pixel of the image and data of pixels therearound in the image, so as to improve an image quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structural diagram of an adaptive image processing device according to a first embodiment of the present invention.

FIG. 2A is a structural diagram of an image processing unit according to the first embodiment of the present invention.

FIG. 2B is a structural diagram of a sharpening unit according to the first embodiment of the present invention.

FIG. 3 is a structural diagram of a control unit according to the first embodiment of the present invention.

FIG. 4A is a schematic diagram illustrating an input image according to the first embodiment of the present invention.

FIG. 4B is a schematic diagram illustrating an output image according to the first embodiment of the present invention.

FIG. 5 is a flow chart illustrating an adaptive image processing method according to the first embodiment of the present invention.

FIG. 6 is a structural diagram of an adaptive image processing device according to a third embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

As discussed above, the conventional image processing technology executes a single image processing process to an entire image, in which those regions undesired to be processed have to be also processed, which causes image distortion. Addressing to the difficulty, the present invention discriminatively processes different pixels of an image according to each pixel of the image and data of pixels therearound in the image, so as to drastically improve an image quality.

### First Embodiment

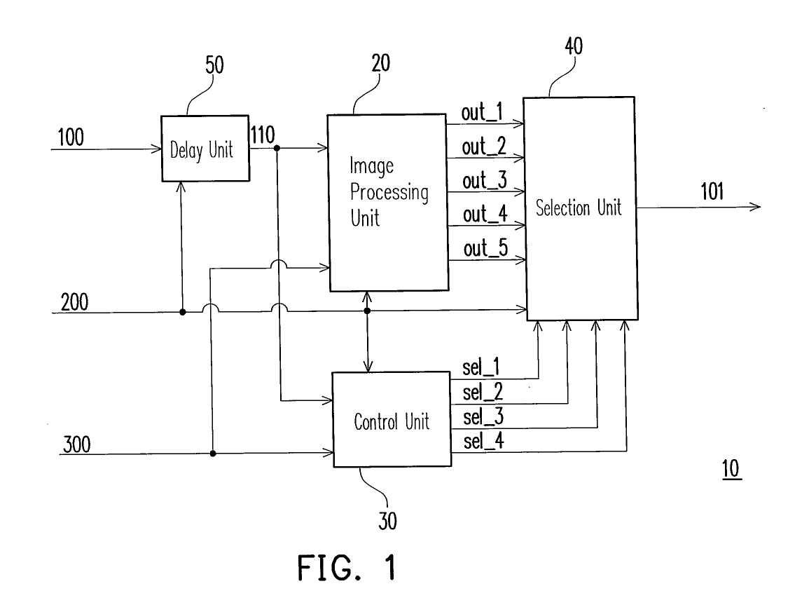

FIG. 1 is a structural diagram of an adaptive image processing device 10 according to a first embodiment of the present invention. Referring to FIG. 1, adaptive image processing device 10 includes an image processing unit 20, a control unit 30, a selection unit 40, and a delay unit 50. The delay unit 50 is coupled to the image processing unit 20, and the control unit 30, for receiving an input image 100, and is adapted to delay inputting an image data 110 of the image 100 into the image processing unit 20 and the control unit 30 according to a timing data 200. The timing data 200, for example, includes a pixel clock signal, a vertical synchronization signal, a horizontal synchronization signal, or the like.

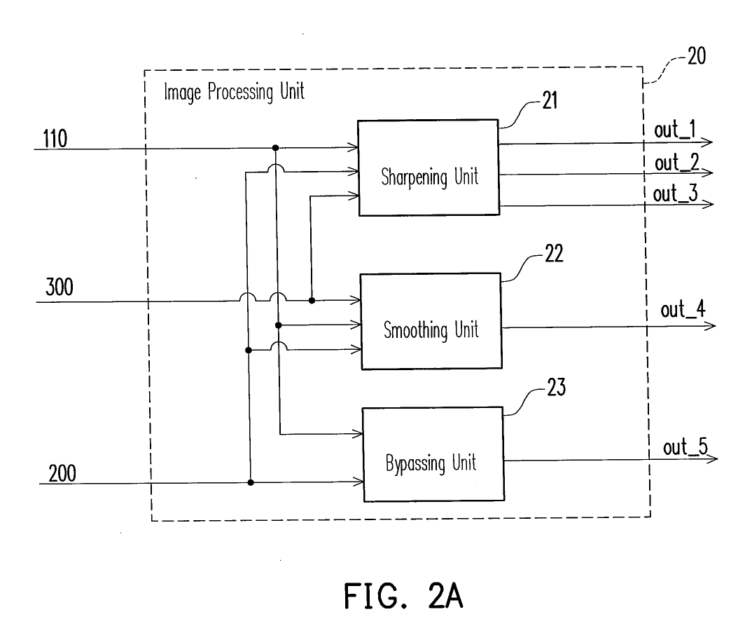

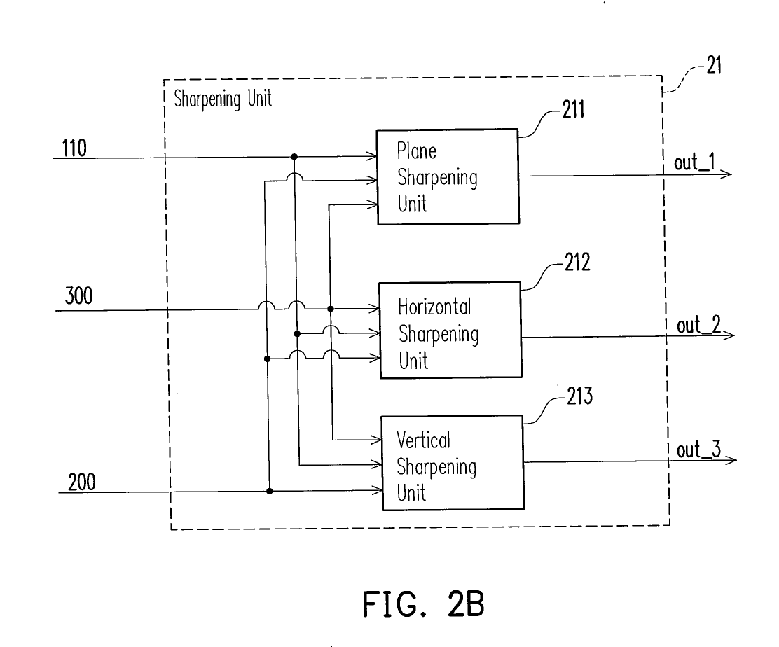

FIG. 2A is a structural diagram of an image processing unit according to the first embodiment of the present invention. FIG. 2B is a structural diagram of a sharpening unit according to the first embodiment of the present invention. Referring to FIGS. 1, 2A, and 2B together, the image processing unit 20 is provided for simultaneously executing a plurality of image processing processes to the image data 110, and obtaining a plurality of output values correspondingly. The image processing unit 20, for example, includes a sharpening unit 21, a smoothing unit 22 and a bypassing unit 23. The sharpening unit 21 includes a plane sharpening unit 211, a horizontal sharpening unit 212, and a vertical sharpening unit 213. The plane sharpening unit 211 is provided for executing a plane sharpness processing process to the image data 110, and generating a corresponding output value out_1. The horizontal sharpening unit 212 is provided for executing a horizontal sharpness processing process to the image data 110, and generating a corresponding output value out_2. The vertical sharpening unit 213 is provided for executing a vertical sharpness processing process to the image data 110, and generating a corresponding output value out_3. The smoothing unit 22 is provided for executing a smoothness processing process to the image data 110, and generating a corresponding output value out_4. The bypassing unit 23 is provided for executing a smoothness processing process to the image data 110, and generating a corresponding output value out_5.

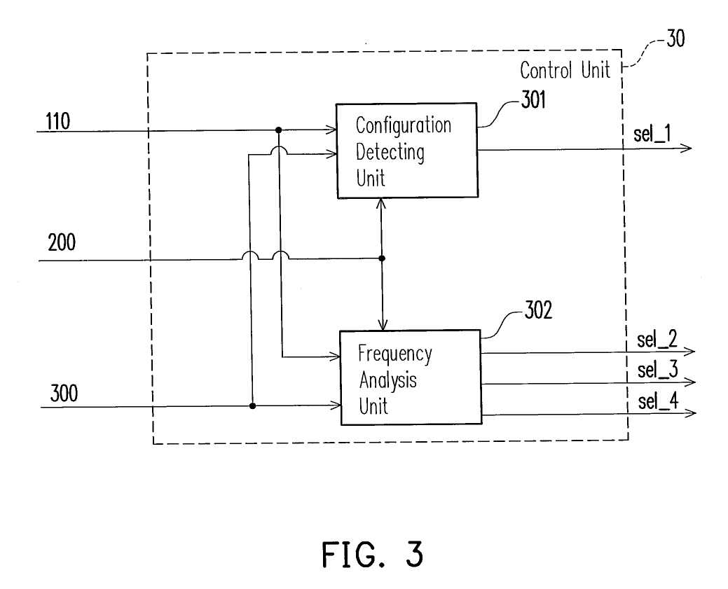

FIG. 3 is a structural diagram of a control unit according to the first embodiment of the present invention. Referring to FIGS. 1 and 3 together, the control unit 30 is coupled to the image processing unit 20 for executing a plurality of image analysis to the image data 110, and obtaining a plurality of corresponding selection signals. According to an aspect of the embodiment, the control unit 30 includes a configuration detecting unit 301 and a frequency analysis unit 302. The configuration detecting unit 301 includes a plurality of image data models stored therein. The image data models are adapted for comparing with the image data 110 for generating a selection signal sel_1. The frequency analysis unit 302 is provided for executing a frequency analysis to the image data 110, so as to identify a sharpness degree or a smoothness degree of the image data 110. In more details, the frequency analysis unit 302 is adapted for executing a horizontal high frequency analysis, a vertical high frequency analysis, and a low frequency analysis to the image data 110, so as to generate selection signals sel_2, sel_3, sel_4, respectively.

Further, the selection unit 40 is coupled to the processing unit 20 and the control unit 30, and is adapted for selecting one from the output values out_1, out_2, out_3, out_4, and out_5 to output as an output data of a pixel of the input image 100, according to the selection signals sel_1, sel_2, sel_3, and sel_4.

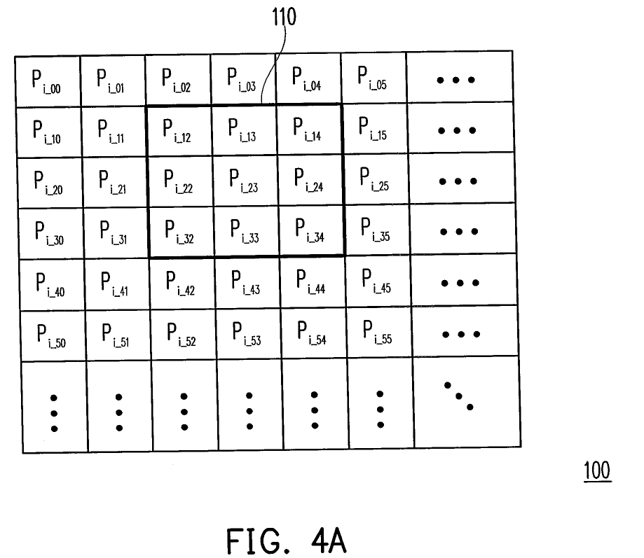

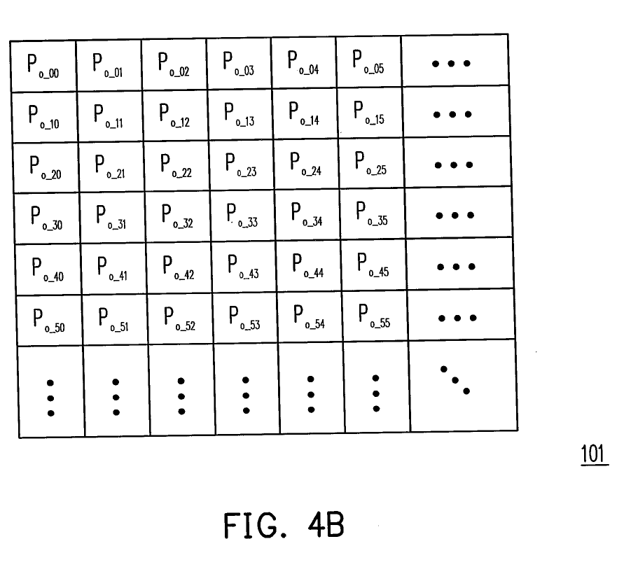

FIG. 4A is a schematic diagram illustrating an input image according to the first embodiment of the present invention. FIG. 4B is a schematic diagram illustrating an output image according to the first embodiment of the present invention. Referring to FIGS. 1, 4A, and 4B together, a conventional image processing method usually executes an image processing process according to each pixel and data of pixels therearound. According to the current embodiment, the adaptive image processing device 10 is also capable of executing an image processing process according to each pixel of the input image 100 and data of pixels therearound, and whereby obtaining a plurality of pixels of an output image 101. As shown in FIG. 4A, the input image 100 includes a plurality of pixels, represented as Pᵢ_{_{—}}₀₀, Pᵢ_{_{—}}₀₁, Pᵢ_{_{—}}₀₂ . . . , Pᵢ_{_{—}}₅₄, Pᵢ_{_{—}}₅₅ . . . . As shown in FIG. 4B, the output image 101 includes a plurality of pixels, represented as Pₒ_{_{—}}₀₀, Pₒ_{_{—}}₀₁, Pₒ_{_{—}}₀₂ . . . , Pₒ_{_{—}}₅₄, Pₒ_{_{—}}₅₅ . . . . A pixel Pᵢ_{_{—}}₂₃ and the data of pixels therearound, i.e., the image data 110, of the input image 100 inputted therein and the pixel Pₒ_{_{—}}₂₃ of the output image 101 are taken for exemplifying the embodiment of the present invention.

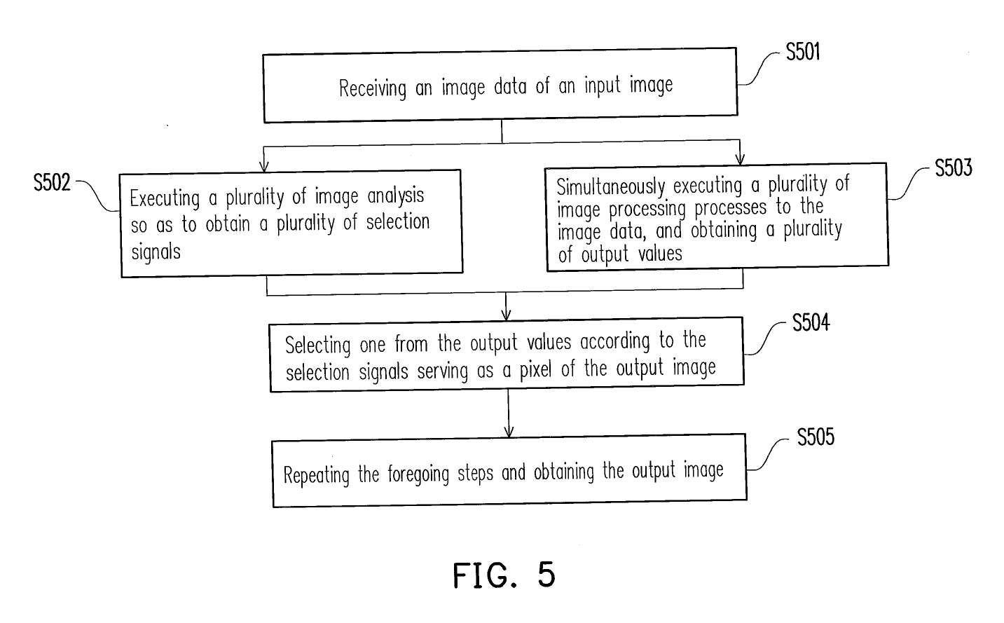

FIG. 5 is a flow chart illustrating an adaptive image processing method according to the first embodiment of the present invention. Referring to FIGS. 1 through 5 together, first, at step S501, the image processing unit 20 and the control unit 30 receive the image data 110 outputted from the delay unit 50. Next, at step S502, the control unit executes comparison with models, horizontal high frequency analysis, vertical high frequency analysis, and low frequency analysis, so as to obtain selection signals sel_1, sel_2, sel_3, and sel_4, and output the selection signals to the selection unit 40. The procedure of setting the selection signals sel_1, sel_2, sel_3, and sel_4 is to be further discussed below.

The configuration detecting unit 301 is adapted for storing a plurality of models therein, and is further adapted for selecting one from the models and setting a threshold Y₁ according to an adjusting data 300. Table 1 shows a model selected by the configuration detecting unit 301. And then the selection signal sel_1 can be set according to the following equation:

|Pᵢ_{_{—}}₁₂−M₁|+|Pᵢ_{_{—}}₁₃−M₂|+|Pᵢ_{_{—}}₁₄−M₃|+|Pᵢ_{_{—}}₂₂−M₄|+|Pᵢ_{_{—}}₂₃−M₅|+|Pᵢ_{_{—}}₂₄−M₆|+|Pᵢ_{_{—}}₃₂−M₇|+|Pᵢ_{_{—}}₃₃−M₈|+|Pᵢ_{_{—}}₃₄−M₉|=X₁ (1)

Table 1 is a model selected by the configuration unit 301.

| | | |
|---|---|---|
| M₁ | M₂ | M₃ |
| M₄ | M₅ | M₆ |
| M₇ | M₈ | M₉ |

According to equation (1), if X₁ is smaller than the threshold Y₁, it indicates that the image data 110 matches with the model, and therefore the selection signal sel_1 is set as 1, or otherwise if X₁ is not smaller than the threshold Y₁, it indicates that the image data 110 does not match with the model, and therefore the selection signal sel_1 is set as 0.

The frequency analysis unit 302 is adapted for setting thresholds Y₂, Y₃, Y₄, according to the adjusting data 300. Next, selection signals sel_2, sel_3, sel_4 can be set according to the following equations:

|Pᵢ_{_{—}}₂₂−Pᵢ_{_{—}}₂₃|+|Pᵢ_{_{—}}₂₄−Pᵢ_{_{—}}₂₃|=X₂ (2)

|Pᵢ_{_{—}}₁₃−Pᵢ_{_{—}}₂₃|+|Pᵢ_{_{—}}₃₃−Pᵢ_{_{—}}₂₃|=X₃ (3)

|Pᵢ_{_{—}}₂₂−Pᵢ_{_{—}}₂₃|+|Pᵢ_{_{—}}₂₄−Pᵢ_{_{—}}₂₃|+|Pᵢ_{_{—}}₁₃−Pᵢ_{_{—}}₂₃|+|Pᵢ_{_{—}}₃₃−Pᵢ_{_{—}}₂₃|=X₄ (4)

According to equation (2), if X₂ is greater than the threshold Y₂, it indicates that the image data 110 has a vertical high frequency characteristic, and therefore the selection signal sel_2 is set as 1, or otherwise if X₂ is not greater than the threshold Y₂, it indicates that the image data 110 does not have the vertical high frequency characteristic, and therefore the selection signal sel_2 is set as 0.

According to equation (3), if X₃ is greater than the threshold Y₃, it indicates that the image data 110 has a horizontal high frequency characteristic, and therefore the selection signal sel_3 is set as 1, or otherwise if X₃ is not greater than the threshold Y₃, it indicates that the image data 110 does not have the horizontal high frequency characteristic, and therefore the selection signal sel_3 is set as 0.

According to equation (4), if X₄ is smaller than the threshold Y₄, it indicates that the image data 110 has a low frequency characteristic, and therefore the selection signal sel_4 is set as 1, or otherwise if X₃ is not smaller than the threshold Y₄, it indicates that the image data 110 does not have the low frequency characteristic, and therefore the selection signal sel_4 is set as 0.

It should be noted that the foregoing equations (1) though (4) are exemplified for illustrating the embodiment of the present invention, without restricting the scope of the present invention. Those skilled in the art may vary the embodiment by employing other practical approaches for setting the selection signals.

On the other hand, at the same time of executing the step S502, the plane sharpening unit 211, the horizontal sharpening unit 212, the vertical sharpening unit 213, the smoothing unit 22, and the bypassing unit 23 of the image processing unit 20 can simultaneously execute a plane sharpness processing process, a horizontal sharpness processing process, a vertical sharpness processing process, a smoothness processing process, and a bypassing process to the image data 110, so as to correspondingly output the output values out_1, out_2, out_3, out_4, out_5, respectively to the selection unit 40, at step S503. The plane sharpening unit 211, the horizontal sharpening unit 212, the vertical sharpening unit 213, the smoothing unit 22, and the bypassing unit 23 of the image processing unit 20 is adapted for independent calculation so that the image processing unit 20 is capable of outputting the output values out_1, out_2, out_3, out_4, out_5 in a sort time, and thus achieving an instant image effect. Further an advantage of simultaneously executing the steps S502 and S503 is that the image processing unit 20 can execute the image processing without any need of waiting for the control unit 30, and therefore a memory for avoiding losing of the data of the input image 100 is not needed. In other words, the embodiment is adapted for an instant image processing, which not only reduce cost of the memory devices, but also achieve an instant output image 101. The calculations for obtaining the output values out_1, out_2, out_3, out_4, out_5 are to be further discussed below.

According to an aspect of the embodiment, the plane sharpening unit 211 stores a plurality of masks, and is adapted to select one from the masks according to the adjusting data 300. For example, table 2 is a schematic diagram illustrating a mask selected by the plane sharpening unit 211. Next, the output value out_1 can be obtained according to equation (5) below:

Pᵢ_{_{—}}₂₃+{Pᵢ_{_{—}}₁₂×(0)+Pᵢ_{_{—}}₁₃×(−2)+Pᵢ_{_{—}}₁₄×(0)+Pᵢ_{_{—}}₂₂×(−2)+Pᵢ_{_{—}}₂₃×(8)+Pᵢ_{_{—}}₂₃×(−2)+Pᵢ_{_{—}}₃₂×(0)+Pᵢ_{_{—}}₃₃×(−2)+Pᵢ_{_{—}}₃₄×(0)}/16=output value out_{—}1 (5)

Table 2 is a mask selected by plane sharpening unit 211.

| | | |
|---|---|---|
| 0 | −2 | 0 |
| −2 | 8 | −2 |
| 0 | −2 | 0 |

The horizontal sharpening unit 212 stores a plurality of masks, and is adapted to select one from the masks according to the adjusting data 300. For example, table 3 is a schematic diagram illustrating a mask selected by the horizontal sharpening unit 212. Next, the output value out_2 can be obtained according to equation (6) below:

Pᵢ_{_{—}}₂₃+{Pᵢ_{_{—}}₂₂×(−1)+Pᵢ_{_{—}}₂₃×(2)+Pᵢ_{_{—}}₂₄×(−1)}/4=output value out_{—}2 (6)

Table 3 is a mask selected by horizontal sharpening unit 212.

| | | |
|---|---|---|
| −1 | 2 | −1 |

The vertical sharpening unit 213 stores a plurality of masks, and is adapted to select one from the masks according to the adjusting data 300. For example, table 4 is a schematic diagram illustrating a mask selected by the vertical sharpening unit 213. Next, the output value out_3 can be obtained according to equation (7) below:

Pᵢ_{_{—}}₂₃+{Pᵢ_{_{—}}₁₂×(−1)+Pᵢ_{_{—}}₂₃×(2)+Pᵢ_{_{—}}₃₃×(−1){/4=output value out_{—}3 (7)

Table 4 mask selected by vertical sharpening unit 213

−1
2
−1

The smoothing unit 22 stores a plurality of masks, and is adapted to select one from the masks according to the adjusting data 300. For example, table 5 is a schematic diagram illustrating a mask selected by the smoothing unit 22. Next, the output value out_4 can be obtained according to equation (8) below:

{Pᵢ_{_{—}}₁₂×(1)+Pᵢ_{_{—}}₁₃×(2)+Pᵢ_{_{—}}₁₄×(1)+Pᵢ_{_{—}}₂₂×(2)+Pᵢ_{_{—}}₂₃×(4)+Pᵢ_{_{—}}₂₄×(2)+Pᵢ_{_{—}}₃₂×(1)+Pᵢ_{_{—}}₃₃×(2)+Pᵢ_{_{—}}₃₄×(1)}/16=output value out_{—}4 (8)

Table 5 is a mask selected by smoothing unit 22.

| | | |
|---|---|---|
| 1 | 2 | 1 |
| 2 | 4 | 2 |
| 1 | 2 | 1 |

The bypassing unit 23 is adapted for directly outputting a pixel Pᵢ_{_{—}}₂₃ as the output value out_5.

It should be noted that the calculations for obtaining the output values out_1, out_2, out_3, out_4, out_5 exemplified above are provided for illustration purpose only without restricting the scope of the present invention. Those skilled in the art should be able to modify the calculations as practically demanded.

Next, at step S504, the selection unit 40 selects one from the output values out_1, out_2, out_3, out_4, out_5 according to the selection signals sel_1, sel_2, sel_3, and sel_4, to output as a pixel Pₒ_{_{—}}₂₃ of the output image 101. For example, the selection unit 40 selects a checklist for the output values in accordance with the selections listed in table 6. When the selection signal sel_1 is 1, the selection unit 40 selects the output value out_1 obtained by executing a plane sharpness processing process to the image data 110. When the selection signals sel_1, sel_2 are 0, 1 respectively, the selection unit 40 selects the output value out_2 obtained by executing a horizontal sharpness processing process to the image data 110.

Further, when the selection signals sel_1, sel_2, sel_3 are 0, 0, 1 respectively, the selection unit 40 selects the output value out_3 obtained by executing a vertical sharpness processing process to the image data 110. When the selection signals sel_1, sel_2, sel_3, sel_4 are 0, 0, 0, 1 respectively, the selection unit 40 selects the output value out_4 obtained by executing a smoothness processing process to the image data 110. When the selection signals sel_1, sel_2, sel_3, sel_4, sel_5 are 0, 0, 0, 0, 1 respectively, the selection unit 40 selects the output value out_5 obtained by executing a bypassing process to the image data 110.

Table 6 is a checklist of selection unit 40 for selecting output values according to selection signals.

| | | | | Output values selected by selection |
|---|---|---|---|---|
| sel_1 | sel_2 | sel_3 | sel_4 | unit 40 |
| 0 | 0 | 0 | 0 | out_5 |
| 0 | 0 | 0 | 1 | out_4 |
| 0 | 0 | 1 | 0 | out_3 |
| 0 | 0 | 1 | 1 | out_3 |
| 0 | 1 | 0 | 0 | out_2 |
| 0 | 1 | 0 | 1 | out_2 |
| 0 | 1 | 1 | 0 | out_2 |
| 0 | 1 | 1 | 1 | out_2 |
| 1 | 0 | 0 | 0 | out_1 |
| 1 | 0 | 0 | 1 | out_1 |
| 1 | 0 | 1 | 0 | out_1 |
| 1 | 0 | 1 | 1 | out_1 |
| 1 | 1 | 0 | 0 | out_1 |
| 1 | 1 | 0 | 1 | out_1 |
| 1 | 1 | 1 | 0 | out_1 |
| 1 | 1 | 1 | 1 | out_1 |

It should be noted that the aforementioned methods of the selection unit 40 for selecting the output values are exemplified for illustration purpose only without restricting the scope of the present invention. Those skilled in the art would be able to modify the methods as practically demanded, which are also construed to be within the scope of the present invention.

Next, at step S505, in a manner similar to the above teachings, other pixels of the output image 101 are calculated, and whereby the output image 101 is obtained. In such a way, the adaptive image processing device 10 is adapted to obtain an output image 101 which image data are discriminatively executed with different image processing processes, according to results of image analysis to the image data of the input image 100. In more details, supposing that the input image 100 is a portrait of a person, a high frequency region of the input image 100, e.g., a region of hairs, is going to be executed with a sharpness processing process, which can make the hairs looked more vivid; on the contrary, a low frequency region of the input image 100, i.e., a region of skin, is going to be executed with a smoothness processing process, so as to make the skin looked more smooth. As such, the adaptive image processing device 10 according to the present invention is capable of drastically improving the image quality.

In the foregoing embodiments, the image processing unit 20 is exemplified as executing 5 types of image processing processes including a plane sharpness processing process, a horizontal sharpness processing process, a vertical sharpness processing process, a smoothness processing process, or a bypassing process, so as to generate output values out_1, out_2, out_3, out_4, out_5, respectively for outputting. The control unit 30 is exemplified as providing 4 types of image analysis including model comparison, horizontal high frequency analysis, vertical high frequency analysis, and low frequency analysis. The plane sharpness processing process, the horizontal sharpness processing process, the vertical sharpness processing process, and the smoothness processing process respectively correspond to the model comparison, the horizontal high frequency analysis, the vertical high frequency analysis, and the low frequency analysis. However, it should be well understood that in other embodiments, the image processing unit 20 may also execute more or less kinds of image processing processes which may also be different from the kinds discussed in the current embodiment. The control unit 30 may also execute more or less kinds of image analysis which may also be different from the types discussed in the current embodiment. Further, the corresponding relationship between the image processing processes and the image analysis can also be varied as practically demanded without restricting the scope of the present invention.

Further, although the current embodiment illustrates the present invention with an input image of a spatial domain, in other embodiments, the input image can be converted from the spatial domain to a frequency domain and executes the image processing and image analysis thereafter, for saving the calculation load.

Furthermore, it should be specifically noted that, although the foregoing embodiment provides a feasible configuration of the adaptive image processing device and a method thereof, it is well known that different manufacturers may vary the configuration in accordance with the spirit of the present invention. In other words, any adaptive image processing device or method thereof featured as discriminatively executing image processing processes to different pixels according to each pixel and data of pixels therearound, should be construed as within the scope of the present invention. Another embodiment is further exemplified for allowing those skilled in the art to further understand the spirit of the present invention, and more conveniently apply the present invention.

### Second Embodiment

Referring to FIG. 1 again, in the first embodiment, the selection signals sel_1 through sel_4 correspond to the output values out_1 through out_4, respectively. In other words, when the selection signal sel_1 is 1, the selection unit 40 selects the output value out_1. When the selection signal sel_1 is 0, then it is determined whether the selection signal sel_2 is 1, and if the selection signal sel_2 is 1, then the selection unit 40 selects the output value out_2. If the selection signal sel_2 is 0, then it is further determined whether the selection signal sel_3 is 1, and if the selection signal sel_3 is 1, then the selection unit 40 selects the output value out_3. Further, if the selection signal sel_3 is 0, then it is further determined whether the selection signal sel_4 is 1, and if the selection signal sel_4 is 1, then the selection unit 40 selects the output value out_4. If the selection signal sel_4 is 0, then the selection unit 40 selects the output value out_5.

Further, when the selection signal sel_is 1, the image processing unit 20 calculates the output value out_1 only, and does not need to calculate the output values out_2 though out_5. Therefore, the control unit 30 outputs the selection signal sel_1 set as 1 to the selection unit 40, and at the same time outputs the selection signal sel_1 to the image processing unit 20 to stop calculating the output values out_2 though out_5 thereby. W % en the selection signal sel_1 is 0 and the selection signal sel_2 is 1, the image processing unit 20 calculates the output value out_2 only, and need not calculate the output values out_1 and out_3 though out_5. Therefore, the control unit 30 outputs the selection signal sel_2 set as 1 to the selection unit 40, and at the same time outputs the selection signal sel_2 to the image processing unit 20 to stop calculating the output values out_1 and out_3 though out_5 thereby. In a similar manner, the rest may be deduced by analogy, and therefore the calculation load of the image processing unit 20 can be drastically decreased.

### Third Embodiment

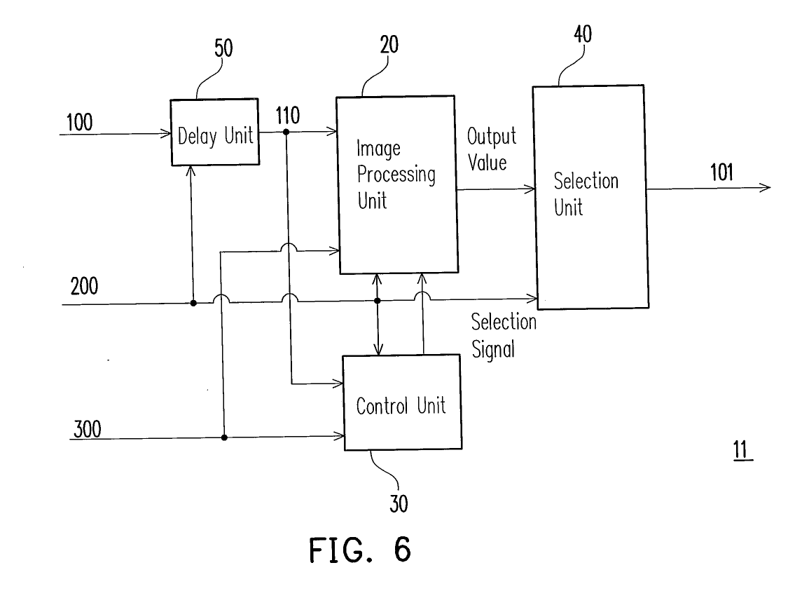

FIG. 6 is a structural diagram of an adaptive image processing device 11 according to a third embodiment of the present invention. Referring to FIGS. 1 and 6 together, the adaptive image processing device 11 is similar to the adaptive image processing device 10 of FIG. 1, except for the control unit 30 of the adaptive image processing device 11 does not output the selection signals to the selection unit 40. On the contrary, the control unit 30 of the adaptive image processing device 11 outputs the selection signals directly to the image processing unit 20. As shown in FIG. 6, the image processing unit 20 executes image processing processes after receiving the selection signals from the control unit 30. The selection unit 40 is adapted for combining the pixels of the output image 101 so as to obtain the output image 101. In such a way, the calculation load of the image processing unit 20 can be further decreased, and the selection unit 40 does not need to select one from many output values serving as a pixel of the output image 101.

In summary, the present invention is adapted for discriminatively executing image processing to different pixels according to each pixel and data of pixels therearound in the image so as to improve an image quality. As shown in the embodiments of the present invention, the embodiments of the present invention have at least the following advantages.
1. The adaptive image processing device is adapted for discriminatively executing image processing processes to different regions according to image analysis results of different regions, in which sharpness and smoothness effects can be achieved in a same image without introducing image second distortion which is usual in conventional image processing operation.
2. When the control unit analyzes the image data of the input image, the image processing unit executes a plurality of kinds of image processing processes to the image data, in which hardware cost of memory devices can be saved by the instant image processing.
3. When the control unit analyzes the image data of the input image, the selection signals obtained thereby are outputted to the image processing unit, by which the image processing unit save unnecessary calculation, and thus decreasing the calculation load of the image processing unit.

It will be apparent to those: skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An adaptive image processing device, comprising:
an image processing unit, for receiving an image data and simultaneously executing a plurality of image processing processes to the image data so as to obtain a plurality of output values;
a control unit, coupled to the image processing unit, for executing at least one image analysis to the image data, and obtaining at least one selection signal; and
a selection unit, for receiving the output values and selecting one from the output values to output according to the selection signal.

2. The adaptive image processing device according to claim 1, further comprising:
a delay unit, adapted for delaying the image data from being inputted into the image processing unit and the control unit.

3. The adaptive image processing device according to claim 1, wherein the image processing unit comprises:
a sharpening unit, coupled to the selection unit, for executing a sharpness processing process to the image data so as to obtain one of the output values;
a smoothing unit, coupled to the selection unit, for executing a smoothness processing process to the image data so as to obtain one of the output values; and
a bypassing unit, coupled to the selection unit, for executing a bypassing process to the image data so as to obtain one of the output values.

4. The adaptive image processing device according to claim 3, wherein the sharpening unit and the smoothing unit adjust degrees for sharpness processing and smoothness processing respectively, according to an adjusting data.

5. The adaptive image processing device according to claim 3, wherein the sharpening unit comprises:
a plane sharpening unit, coupled to the selection unit, for executing a plane sharpness processing process to the image data so as to obtain a plane sharpening output value, which serves as one of the output values;
a horizontal sharpening unit, coupled to the selection unit, for executing a horizontal sharpness processing process to the image data, so as to obtain a horizontal sharpening output value, which serves as one of the output values; and
a vertical sharpening unit, coupled to the selection unit, for executing a vertical sharpness processing process to the image data, so as to obtain a vertical sharpening output value, which serves as one of the output values.

6. The adaptive image processing device according to claim 1, wherein the control unit comprises:
a configuration detecting unit, comprising a plurality of built-in image data models, for receiving the image data and comparing the received image data with the built-in image data models, so as to obtain a first selection signal; and
a frequency analysis unit, receiving the image data and executing a frequency analysis to the received image data so as to obtain a second selection signal,
wherein the first selection signal and the second selection signal constitute the selection signal.

7. The adaptive image processing device according to claim 1, wherein the frequency analysis executed by the frequency analysis unit comprises a horizontal high frequency analysis, a vertical high frequency analysis, or a low frequency analysis.

8. An adaptive image processing method comprises:
receiving an image data of an input image;
executing a plurality of image analysis so as to obtain a selection signal; and
obtaining an output value according to the selection signal, the output value being taken as a pixel of an output image corresponding to the input image, wherein the output value is one of a plurality of output values obtained by executing a plurality of image processing processes to the image data, and the plurality of image processing processes correspond to the plurality of image analysis respectively.

9. The adaptive image processing method according to claim 8, wherein the step of obtaining the output value according to the selection signal further comprises:
executing one of the image processing processes to the image data according to the selection signal so as to obtain the output value.

10. The adaptive image processing method according to claim 9, wherein if the selection signal indicates that the image data matches with an image data model, the output value obtained according to the selection signal is obtained by executing a plane sharpness processing process to the image data.

11. The adaptive image processing method according to claim 9, wherein if the selection signal indicates that the image data has a high frequency characteristic, the output value obtained according to the selection signal is obtained by executing a sharpness processing process to the image data.

12. The adaptive image processing method according to claim 9, wherein if the selection signal indicates that the image data has a horizontal high frequency characteristic, the output value obtained according to the selection signal is obtained by executing a horizontal sharpness processing process to the image data.

13. The adaptive image processing method according to claim 9, wherein if the selection signal indicates that the image data has a vertical high frequency characteristic, the output value obtained according to the selection signal is obtained by executing a vertical sharpness processing process to the image data.

14. The adaptive image processing method according to claim 9, wherein if the selection signal indicates that the image data has a low frequency characteristic, the output value obtained according to the selection signal is obtained by executing a smoothness processing process to the image data.

15. The adaptive image processing method according to claim 8, further comprising:
executing the plurality of image processing processes to the image data, so as to obtain the plurality of output values.

16. The adaptive image processing method according to claim 15, wherein the image processing processes comprises a plane sharpness processing process, a horizontal sharpness processing process, a vertical sharpness processing process, a smoothness processing process, or a bypassing process.

17. The adaptive image processing method according to claim 8, wherein the image analysis comprises a configuration detecting analysis, a horizontal high frequency analysis, a vertical high frequency analysis, or a low frequency analysis.

18. The adaptive image processing method according to claim 17, wherein the configuration detecting analysis, the horizontal high frequency analysis, the vertical high frequency analysis, and the low frequency analysis respectively correspond to the plane sharpness processing process, the horizontal sharpness processing process, the vertical sharpness processing process, and the smoothness processing process.

19. The adaptive image processing method according to claim 8, wherein the selection signal indicates a frequency characteristic of the image data.
